(19) United States
(12) Patent Application Publication
(10) Pub. No.: US 2006/0068775 A1
(43) Pub. Date: Mar. 30, 2006

(54) Apparatus and method for detecting wireless local area network signals

(75) Inventors: Jack Wu, Zhoughe City (TW); Venson Liao, Zhoughe City (TW); Chaowu Chien, Zhoughe City (TW); Dennis Lin, Zhoughe City (TW)

Correspondence Address: TROXELL LAW OFFICE PLLC, SUITE 1404, 5205 LEESBURG PIKE, FALLS CHURCH, VA, 22041, US

(73) Assignee: Raytac Corp.

(21) Appl. No.: 10/950,528

(22) Filed: Sep. 28, 2004

(51) Int. Cl. H04Q 7/20

(52) U.S. Cl. 455/426.2

(57) ABSTRACT

An apparatus and method for detecting wireless local area network (WLAN) signals scans an area for radio-wave signals that meet IEEE802.11a, 802.11b, and 802.11g standards, and converts any detected radio-wave signal into a received signal strength indicator (RSSI) data, which is stored, recorded, and compared by a control unit with WLAN properties to determine whether there is a WLAN set up in the scanned area, or bearings and strength of any detected WLAN signal, making the detection highly discriminating and sensitive.

### FIELD OF THE INVENTION

The present invention relates to an apparatus and method for detecting wireless local area network (WLAN) signals, in which a signal-receiving unit is employed to scan an area for radio-wave signals possibly existing in the area and meeting IEEE802.11a, 802.11b, and 802.11g standards, and any detected radio-wave signal is recorded and compared with WLAN properties to determine existence of any WLAN in the scanned area, or bearings and strength of any detected WLAN signal.

### BACKGROUND OF THE INVENTION

In a currently available method for detecting WLAN signals, a signal-receiving unit is used to detect electric waves in all 2.4 GHz industrial, scientific, and medical (ISM) bands in a detected area. Since 2.4 GHz is a general ISM band for all countries, there are signals of 2.4 GHz from various kinds of things in our living environment, such as, for example, microwave stoves, indoor wireless phones, Bluetooth devices, etc. FIG. 1 is a block diagram of a conventional way for detecting such signals. When a power supply unit A6 is turned on, an antenna A1 receives all different pulse signals of 2.4 GHZ, which are directly amplified by amplifiers A2 and filtered by a filter A3, and then converted from analogous to digital signal by a voltage converter A4. The converted result is then displayed at a display A5 to show whether there is any signal of 2.4 GHz in a detected area. Since the received signal is not compared and analyzed in the above-described conventional method for detecting WLAN signals, it is impossible to determine whether the received pulse signals of 2.4 GHz are WLAN signals. That is, with the conventional detecting method, a user can only detect whether there is any 2.4 GHz signal in the detected area.

With the quickly developed global wireless communication technologies and the huge demands for wireless access to the Internet, most countries in the world are now positively engaging with foundational constructions for WLAN. Before the WLAN is widely available for use, it is an important issue for the related industries to have an improved method for detecting WLAN signals to make the wireless access to the Internet more conveniently and quickly. It is therefore tried by the inventor to develop an improved and practical apparatus and method for detecting WLAN signals more accurately.

### SUMMARY OF THE INVENTION

A primary object of the present invention is to provide an apparatus and method for detecting WLAN signals, with which an area is scanned for any radio-wave signals meeting IEEE802.11a, 802.11b, and 802.11g standards, and any detected signal is converted into a received signal strength indicator (RSSI) data for use by a control unit as a basis in comparing and determining the nature of the detected signal.

Another object of the present invention is to provide an apparatus and method for detecting WLAN signals, in which an RSSI data is compared with WLAN properties to determine whether there is any WLAN signal existing in a detected area.

A further object of the present invention is to provide an apparatus and method that includes a lamp display unit to quickly show whether there is any WLAN set up in a detected area, or bearings and strength of any detected WLAN signal as a reference for WLAN users and engineers.

A still further object of the present invention is to provide an apparatus and method for detecting WLAN signals that is convenient and economical for use in detecting multiple types of WLAN signals to largely reduce the costs of such detecting apparatus.

To achieve the above and other objects, the apparatus and method for detecting WLAN signals of the present invention scans an area for radio-wave signals that meet IEEE802.11a, 802.11b, and 802.11g standards, and converts any detected radio-wave signal into a received signal strength indicator (RSSI) data, which is stored, recorded, and compared by a control unit with WLAN properties to determine existence of any WLAN in the scanned area, or bearing and strength of any detected WLAN signal, making the detection highly discriminating and sensitive.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional apparatus for detecting WLAN signals;

FIG. 2 is a block diagram of an apparatus for detecting WLAN signals according to the present invention; and

FIG. 3 is a flowchart showing steps included in a method for detecting WLAN signals according to the present invention.

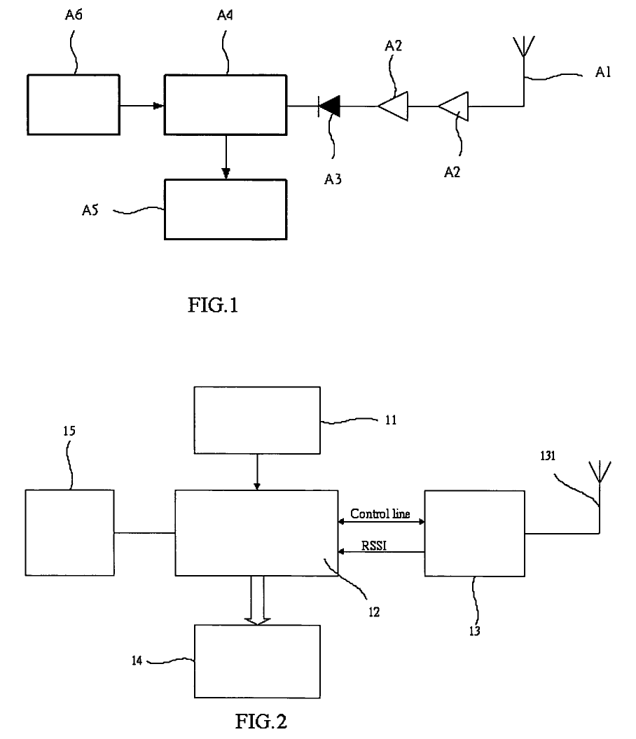

### DETAILED DESCRIPTION OF THE PREFERRED EMBODIMENTS

Please refer to FIG. 2 that is a block diagram of an apparatus for detecting wireless local area network (WLAN) signals according to the present invention. As shown, the detecting apparatus of the present invention mainly includes an on-off control unit 11 for controlling a supply of driving power source to the detecting apparatus; a control unit 12 for recording and comparing data of radio-frequency signals; a radio control unit 13 for converting a detected radio-frequency signal into an RSSI (received signal strength indicator) data, and including an antenna 131 provided at an end thereof for receiving radio-frequency signals; a lamp display unit 14 for displaying any result from the comparison made by the control unit 12 and being replaceable with any other functionally equivalent display device; and a battery 15 for storing power supply needed to drive the detecting apparatus.

When it is desired to detect WLAN signals using the detecting apparatus of the present invention, first turn on the on-off control unit 11 to actuate the detecting apparatus. At this point, the control unit 12 updates frequency data in the radio control unit 13, and the radio control unit 13 and the antenna 131 thereof scans and receives, respectively, all radio-wave signals in the scanned area that meet IEEE802.11a, 802.11b, and 802.11g standards. The radio control unit 13 also converts any detected radio-frequency signal into the RSSI data, which is then recorded in the control unit 12 and compared with all WLAN properties to verify the existence of any WLAN, and bearings and strength of any detected signal. Any result from the comparison made by the control unit 12 is displayed at the lamp display unit 14 as a reference for WLAN users and engineers.

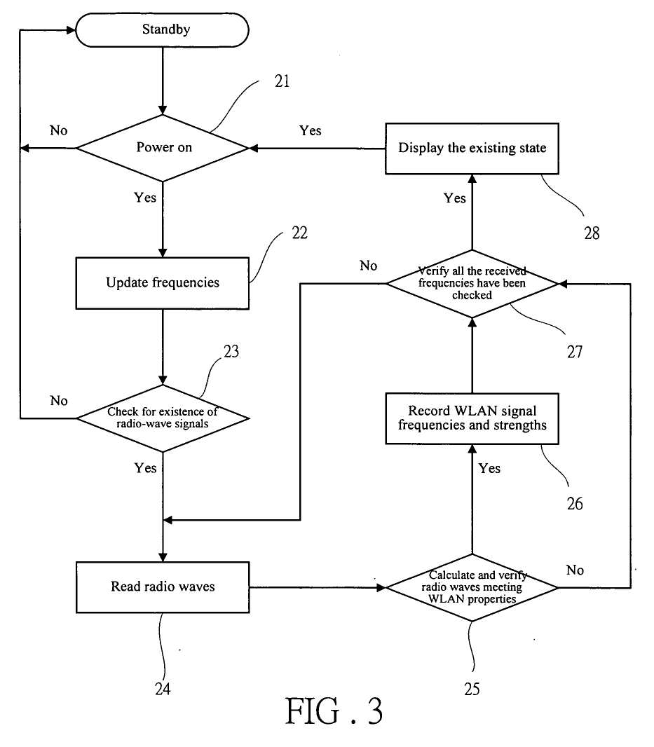

FIG. 3 is a flowchart showing steps included in a method for detecting WLAN signals using the detecting apparatus of the present invention. As shown, the detecting method of the present invention includes the following steps:

Power on (Step 21): The on-off control unit 11 is turned on to actuate the control unit 12. Step 22 is executed if the on-off control unit 11 is successfully turned on, or the detecting apparatus returns to a standby state and Step 21 is executed again.

Update frequency (Step 22): The control unit 12 updates the radio control unit 13 to frequencies that are possibly existing in WLANs.

Check for existence of radio-wave signals (Step 23) The radio control unit 13 and the antenna 131 detect for any radio wave existing in the detected area. Step 24 is executed if any radio-wave signal meeting IEEE802.11a, 802.11b, and 802.11g standards is detected, or the detecting apparatus returns to the standby state and Step 21 is executed again.

Read radio waves (Step 24): The radio control unit 13 converts the received radio waves into the RSSI data for reading by the control unit 12.

Calculate and verify radio waves meeting WLAN properties (Step 25): The control unit 12 reads the RSSI data and compares them with WLAN properties one by one to verify existence of any WLAN signal. Step 26 is executed if any WLAN signal meeting WLAN properties is found, or Step 27 is executed.

Record WLAN signal frequency and strength (Step 26): The detected RSSI data, including the frequencies, bearings, and strengths of the detected WLAN signals, are recorded in the control unit 12, and Step 27 is executed.

Verify all the received frequencies have been checked (Step 27): The control unit 12 verifies whether all the received frequencies have been checked. If yes, Step 28 is executed. Otherwise, Step 24 is executed again.

Display an existing state (Step 28): The lamp display unit 15 displays the frequencies, bearings, or strengths of detected signals.

When a WLAN user or engineer uses the apparatus for detecting WLAN signals according to the present invention to detect any WLAN signal, the control unit 12 first updates the frequencies in the radio control unit 13 that are possibly existing in WLANs, that is, radio-wave signals that meet IEEE802.11a, 802.11b, and 802.11g standards, and then, the radio control unit 13 and the antenna 131 scans and receives, respectively, all the WLAN frequencies possibly existing in the detected area. The scanned signals are converted by the radio control unit 13 into the RSSI data, which is then compared with WLAN properties and recorded in the control unit 12 for verifying the existence of any WLAN signal, and the bearings and strength of the existed WLAN signal. The comparison results are displayed on the lamp display unit 14 as a reference for the wireless user and engineer. The detecting apparatus of the present invention has the advantage of high discrimination and sensitivity to enable convenient and practical use thereof.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An apparatus for detecting wireless local area network (WLAN) signals, comprising:
an on-off control unit for controlling a supply of driving power source to said detecting apparatus;
a control unit for recording and comparing data of radio-frequency signals;
a radio control unit for converting a detected radio-frequency signal into an RSSI (received signal strength indicator) data;
a lamp display unit for displaying any result from the comparison made by said control unit; and
a battery for storing power supply needed to drive said detecting apparatus.

2. The apparatus for detecting WLAN signals as claimed in claim 1, wherein said radio control unit includes an antenna provided at an end thereof for receiving radio-frequency signals.

3. The apparatus for detecting WLAN signals as claimed in claim 1, wherein said lamp display unit is replaceable with any other functionally equivalent display device.

4. A method for detecting WLAN signals, comprising the steps of (a) powering on an apparatus for detecting WLAN signals; (b) updating frequencies stored in a radio control unit of said detecting apparatus to those possibly existing in WLANs; (c) checking for existence of radio-wave signals in a detected area that meet IEEE802.11a, 802.11b, and 802.11g standards; (d) reading any detected radio wave; (e) calculating and verifying whether there is any detected radio wave meeting WLAN properties; (f) recording bearings and strength of any verified WLAN signal; (g) verifying all existing frequencies have been checked in step (c); and (h) displaying any detected state.
